(19) United States
(12) Patent Application Publication
(10) Pub. No.: US 2018/0166738 A1
(43) Pub. Date: Jun. 14, 2018

(54) Lithium Ion Secondary Battery

(71) Applicant: Hitachi, Ltd., Chiyoda-ku, Tokyo (JP)

(72) Inventors: Naoki KIMURA, Tokyo (JP); Eiji SEKI, Tokyo (JP); Seogchul SHIN, Tokyo (JP)

(21) Appl. No.: 15/747,223

(22) PCT Filed: Aug. 26, 2016
(86) PCT No.: PCT/JP2016/074944

§ 371 Date: Jan. 24, 2018

(30) Foreign Application Priority Data
Sep. 3, 2015 (JP) 2015-173720

(51) Int. Cl. H01M 10/052; H01M 4/133; H01M 4/38; H01M 4/48; H01M 4/62; H01M 4/134

(52) U.S. Cl. CPC H01M 10/052; H01M 4/133; H01M 4/386; H01M 2004/027; H01M 4/62; H01M 4/134; H01M 4/387; H01M 4/48

(57) ABSTRACT

Capacity of a lithium ion secondary battery is increased and life of the lithium ion secondary battery is prolonged. A lithium ion secondary battery includes a negative electrode, a positive electrode, and a separator. The negative electrode contains a silicon-containing Si-based negative electrode active material, graphite, and a negative electrode binder. Discharge capacity Q (Ah/kg) of the negative electrode, and breaking strength A (MPa) and breaking elongation B (%) of the negative electrode binder alone satisfy the following relational formula:

3×Q≥(A×B÷10)≥Q

### TECHNICAL FIELD

The present invention relates to a lithium ion secondary battery.

### BACKGROUND ART

In recent years, an electric vehicle (EV) has been developed by automobile manufacturers due to problems of global warming and exhausted fuel. A lithium ion secondary battery having a high energy density has been required as a power source of the electric vehicle.

As a negative electrode active material having a high energy density, a Si-containing active material is expected. However, Si has a large volume change due to charge and discharge, and therefore Si destroys a conductive network between active material particles. Therefore, use of a Si-containing active material has a disadvantage that cycle deterioration is large.

PTL 1 discloses a negative electrode material for a lithium secondary battery consisting of composite powder in which SiOₓ (0≤x<2) surface is coated with soft carbon. PTL 1 describes that soft carbon is easily graphitized and that polyimide is used as a binder.

### CITATION LIST

### Patent Literature

PTL 1: JP 2013-197069 A

### SUMMARY OF INVENTION

### Technical Problem

As described above, attempts have been made to suppress expansion and shrinkage and to improve cycle life using polyamide, polyimide, or polyamideimide as a binder. However, there has been no report concerning other physical property values of the binder, the amount of a Si-containing active material, or capacity.

As a result of intensive studies, we have found that a correlation between toughness (A×B) which is a parameter represented by a product of breaking strength (A) and breaking elongation (B) and cycle characteristics is much higher than a correlation between breaking strength of a binder and cycle characteristics. Furthermore, in a case where there is an optimum range in the toughness (A×B) and the toughness (A×B) is too large, the amount of an imide group in the binder is increased. Therefore, it has been found that Li is trapped by an imide group in a negative electrode binder, irreversible capacity of the negative electrode is obtained, and discharge capacity of the negative electrode is lowered. That is, it has been found that the discharge capacity and the cycle characteristics are in a trade-off relationship. Furthermore, it has been also found that even in a case where the mixing amount of a Si-based active material (discharge capacity of negative electrode) is changed, an optimum physical property value thereof changes.

An object of the present invention is to increase capacity of a lithium ion secondary battery and to prolong life of the lithium ion secondary battery.

### Solution to Problem

The lithium ion secondary battery of the present invention includes a negative electrode, a positive electrode, and a separator. The negative electrode contains a silicon-containing Si-based negative electrode active material, graphite, and a negative electrode binder. Discharge capacity Q (Ah/kg) of the negative electrode, and breaking strength A (MPa) and breaking elongation B (%) of the negative electrode binder alone satisfy the following relational formula (1).

3×Q≥(A×B÷10)≥Q (1)

### Advantageous Effects of Invention

The present invention can realize a lithium ion secondary battery having high capacity and long life. In other words, a lithium ion secondary battery having excellent initial capacity and cycle characteristics can be obtained.

### BRIEF DESCRIPTION OF DRAWINGS

FIG. 1 is an exploded view illustrating a lamination type electrode group inside a laminate cell.

FIG. 2 is an exploded perspective view illustrating a laminate cell.

### DESCRIPTION OF EMBODIMENTS

Hereinafter, the present invention will be described by with reference to Examples. The present invention is not limited to Examples described below. Note that Examples use a lamination type laminate cell. However, in addition to the lamination type laminate cell, even using a wound structure or a structure enclosed in a metal can, a similar effect is obtained.

### Examples

(Negative Electrode Active Material and Negative Electrode Binder)

Table 1 indicates negative electrode active materials in Examples and Comparative Examples.

As illustrated in Table 1, a mixture of a Si-based active material a and a carbon-based active material b was used as a negative electrode active material. The Si-based active material a is a Si alloy or silicon oxide. The carbon-based active material b is graphite. A mixing ratio (a:b) between the Si-based active material a and the carbon-based active material b is on a mass basis.

Hereinafter, the mixing ratio (a:b) is also simply referred to as a “mixing ratio”.

TABLE 1

| | Negative electrode active material | | |
|---|---|---|---|
| | | | Active material |
| | Si-based active | Carbon-based | mixing ratio |
| Item | material a | active material b | (a:b) |
| Example 1 | Si alloy | Graphite | 50:50 |
| Example 2 | Si alloy | Graphite | 50:50 |
| Example 3 | Si alloy | Graphite | 50:50 |
| Example 4 | Si alloy | Graphite | 50:50 |
| Example 5 | Si oxide | Graphite | 50:50 |
| Example 6 | Si alloy | Graphite | 20:80 |
| Example 7 | Si alloy | Graphite | 90:10 |
| Example 8 | Si oxide | Graphite | 20:80 |
| Example 9 | Si oxide | Graphite | 90:10 |
| Comparative | Si alloy | Graphite | 50:50 |
| Example 1 | | | |
| Comparative | Si alloy | Graphite | 50:50 |
| Example 2 | | | |
| Comparative | Si alloy | Graphite | 50:50 |
| Example 3 | | | |
| Comparative | Si alloy | Graphite | 50:50 |
| Example 4 | | | |
| Comparative | Si oxide | Graphite | 50:50 |
| Example 5 | | | |
| Comparative | Si oxide | Graphite | 50:50 |
| Example 6 | | | |
| Comparative | Si alloy | Graphite | 20:80 |
| Example 7 | | | |
| Comparative | Si alloy | Graphite | 20:80 |
| Example 8 | | | |
| Comparative | Si alloy | Graphite | 10:90 |
| Example 9 | | | |
| Comparative | Si alloy | Graphite | 10:90 |
| Example 10 | | | |
| Comparative | Si alloy | Graphite | 90:10 |
| Example 11 | | | |
| Comparative | Si alloy | Graphite | 90:10 |
| Example 12 | | | |
| Comparative | Si oxide | Graphite | 10:90 |
| Example 13 | | | |

A Si alloy is usually in a state in which fine particles of metal silicon (Si) are dispersed in each particle of another metal element, or in a state in which another metal element is dispersed in each particle of Si. The other metal element only needs to contain any one or more of Al, Ni, Cu, Fe, Ti, and Mn. The Si alloy can be manufactured by mechanical synthesis by a mechanical alloy method or by heating and cooling a mixture of Si particles and other metal elements. In the present Examples, the former one was used. As a composition of the Si alloy, an atomic ratio of Si:other metal element is desirably 50:50 to 90:10, and more desirably 60:40 to 80:20. The ratio is particularly desirably 65:35 to 75:25.

In the present Examples, Si₇₀Ti₃₀ was used as the ratio 70:30. However, Si₇₀Ti₁₀Fe₁₀Al₁₀, Si₇₀Al₃₀, Si₇₀Ni₃₀, Si₇₀Cu₃₀, Si₇₀Fe₃₀, Si₇₀Ti₃₀, Si₇₀Mn₃₀, Si₇₀Ti₁₅Fe₁₅, Si₇₀Al₁₀Ni₂₀, or the like may be used. Note that the Si alloy Si₇₀Ti₃₀ used in the present Examples has a D50 average particle diameter of 3 μm as measured by a laser diffraction method and a specific surface area of 6 m²/g as measured by a nitrogen adsorption BET method.

Silicon oxide is usually in a state in which fine particles of metal silicon (Si) are dispersed in each particle of silicon dioxide (SiO₂). Silicon oxide is manufactured by heating a mixture of silicon dioxide particles and metal silicon particles to generate silicon monoxide gas, and cooling the resulting product to precipitate an amorphous silicon oxide particle. This amorphous silicon oxide particle is represented by a general formula SiOₓ. Note that in the silicon oxide used for the negative electrode active material of the lithium ion secondary battery according to the present invention, x in the above general formula SiOₓ is preferably in a range of 1.0≤x≤1.5, and more preferably in a range of 1.0≤x<1.2.

By oxidizing the silicon oxide particles obtained by the above step by a heat treatment, the ratio of oxygen in the silicon oxide particles can be increased. That is, the value of x can be increased. However, in the silicon oxide particles having x exceeding 1.5, obtained by the heat treatment, the ratio of silicon dioxide generated by a disproportionation reaction is large. Silicon dioxide is inactive. Therefore, a case where such silicon oxide particles are used for a negative electrode active material of a lithium ion secondary battery is not preferable because irreversible capacity is increased. In the present Examples, x=1.0 was used as SiOₓ. This silicon oxide (SiO) has a D50 average particle diameter of 5 μm as measured by a laser diffraction method and a specific surface area of 10 m²/g as measured by a nitrogen adsorption BET method.

As graphite, a graphitic material such as natural graphite or artificial graphite can be used. Natural graphite is desirable from a viewpoint of cost. However, a surface thereof may be covered with non-graphitizable carbon. In the present Examples, natural graphite having d002 of 3.356 Å or less, Lc (002) of 1000 Å or more, and La (110) of 1000 Å or more as crystallinity was used. This natural graphite has a D50 average particle diameter of 20 μm as measured by a laser diffraction method and a specific surface area of 4 m²/g as measured by a nitrogen adsorption BET method.

In the present Examples, polyamideimide was used as a binder, but polyamide, polyimide, a mixture thereof, or a mixed binder with another binder such as PVDF or SBR may be used. Note that polyamideimide is not particularly strictly defined, and a mixed binder of polyimide and polyamideimide is also referred to as polyamideimide. An example of the structure of polyamideimide is represented by the following structural formula (1).

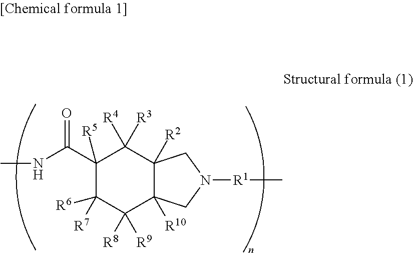

R¹ in the above structural formula (1) represents an alkylene group having 1 to 18 carbon atoms, an arylene group, benzene, or the like, and may contain a nitrogen oxygen atom, a sulfur atom, or a halogen atom. Furthermore, each of R² to R¹⁰ in the above structural formula (1) represents a hydrogen atom, an alkyl group, or an aryl group. By increasing the number of carbon atoms of R¹ to R³ or by increasing n in the above structural formula (1) and changing the amount of a polymer, that is, by increasing an imide group, physical property values (breaking strength A and breaking elongation B) of a binder were changed. Note that in the above structural formula (1), the ring structure at the center may be a benzene ring or another unsaturated ring.

Table 2 illustrates physical property values of negative electrode binders in Examples and Comparative Examples.

Breaking strength A (MPa) of a negative electrode binder was defined as strength obtained when the negative electrode binder was pulled at a rate of 0.2 m/min using a tensile tester (Autograph AG-Xplus manufactured by Shimadzu Corporation) and was broken, and was calculated from the following formula.

A=(tensile load)/(cross-sectional area of negative electrode binder piece) (2)

In addition, breaking elongation B (%) of a negative electrode binder was defined as elongation obtained when the negative electrode binder was pulled at a rate of 0.2 m/min using a tensile tester and was broken, and was calculated from the following formula.

B=100×{(length of negative electrode binder piece after pulling)−(length of negative electrode binder piece before pulling)}/(length of negative electrode binder piece before pulling) (3)

Note that the size of a test piece was 3 cm×3 cm. A measurement temperature was 25° C.

TABLE 2

| | Binder physical property value | | |
|---|---|---|---|
| | Breaking | Breaking | A × B ÷ 10 |
| Item | strength A (MPa) | elongation B (%) | (MPa) |
| Example 1 | 160 | 50 | 800 |
| Example 2 | 160 | 80 | 1280 |
| Example 3 | 170 | 100 | 1700 |
| Example 4 | 200 | 120 | 2400 |
| Example 5 | 160 | 80 | 1280 |
| Example 6 | 160 | 80 | 1280 |
| Example 7 | 160 | 80 | 1280 |
| Example 8 | 160 | 80 | 1280 |
| Example 9 | 160 | 80 | 1280 |
| Comparative | 90 | 60 | 540 |
| Example 1 | | | |
| Comparative | 110 | 15 | 165 |
| Example 2 | | | |
| Comparative | 150 | 20 | 300 |
| Example 3 | | | |
| Comparative | 250 | 120 | 3000 |
| Example 4 | | | |
| Comparative | 90 | 60 | 540 |
| Example 5 | | | |
| Comparative | 250 | 120 | 3000 |
| Example 6 | | | |
| Comparative | 90 | 60 | 540 |
| Example 7 | | | |
| Comparative | 200 | 120 | 2400 |
| Example 8 | | | |
| Comparative | 160 | 80 | 1280 |
| Example 9 | | | |
| Comparative | 160 | 50 | 800 |
| Example 10 | | | |
| Comparative | 90 | 60 | 540 |
| Example 11 | | | |
| Comparative | 250 | 120 | 3000 |
| Example 12 | | | |
| Comparative | 160 | 50 | 800 |
| Example 13 | | | |

A method for manufacturing a binder alone is as follows.

A binder was manufactured by performing coating on a surface of a glass plate using a 100 μm blade coater and thermally curing the resulting product in vacuum at 300° C. for one hour. The size of the coating was 5 cm×10 cm.

(Manufacture of Negative Electrode)

A negative electrode was manufactured by manufacturing a negative electrode mixture slurry, then coating a top surface of a current collecting foil with the negative electrode mixture slurry, and pressing the resulting product. The negative electrode mixture slurry was manufactured using the above negative electrode active material and binder, and further using acetylene black (HS100) as a conductive material at a weight ratio of 92:5:3 in order while an NMP solvent was mixed therewith so as to obtain viscosity of 5000 to 8000 mPa. In the present Examples, NMP was used as a solvent. However, water, 2-butoxyethanol, butylcellosolve, N,N-dimethylacetamide, diethyleneglycol diethyl ether, or the like may be used, or a mixture thereof may be used. A planetary mixer was used for manufacturing the slurry.

A top surface of a copper foil was coated with the obtained negative electrode slurry using a desk-top comma coater. For a current collecting foil, a SUS steel foil with low specific gravity and high strength is more effective for improving cycle life or the like than the copper foil. However, the copper foil was selected from a viewpoint of cost. The coating amount of a negative electrode was adjusted such that a volume ratio between a positive electrode and the negative electrode was 1.0 when the coating amount of the positive electrode was 240 g/m². The negative electrode was manufactured such that the coating amount was 10 g/m² or more and 100 g/m² or less.

The negative electrode was primarily dried through a drying furnace at 90° C. as a drying temperature. As the drying temperature during coating of the negative electrode in the present invention, a temperature of 80° C. or higher and 120° C. or lower is effective. However, a temperature of 90° C. or higher and 100° C. or lower is most effective.

Then, the density of the coated negative electrode was adjusted by roll pressing. Incidentally, pressing was performed such that the electrode had pores of about 20 to 40%, a negative electrode containing a silicon oxide active material was manufactured at a density of 1.3 to 1.5 g/cm³, and a negative electrode containing a Si alloy was manufactured at a density of 2.0 to 2.4 g/cm³. Thereafter, polyamideimide was thermally cured in vacuum at 300° C. for one hour. Note that thermal curing may be performed in nitrogen, and any curing time of a resin may be used.

(Separator and Electrolytic Solution)

Any separator may be used as long as being a material through which a lithium ion does not pass due to heat shrinkage. For example, polyolefin is used. The polyolefin is characterized by mainly containing at least one of polyethylene, polypropylene, and the like, but may contain a heat-resistant resin such as polyamide, polyamideimide, polyimide, polysulfone, polyethersulfone, polyphenylsulfone, or polyacrylonitrile. Furthermore, one surface or both surfaces may be coated with an inorganic filler layer. The inorganic filler layer is characterized by containing at least one of SiO₂, Al₂O₃, montmorillonite, mica, ZnO, TiO₂, BaTiO₃, and ZrO₂, but is most preferably SiO₂ or Al₂O₃ from a viewpoint of cost and performance. In the present Examples, a 25 μm three-layered film containing polyethylene between polypropylene and polypropylene was used.

An electrolytic solution obtained by dissolving 1M LiPF₆ electrolyte in a solvent of EC:EMC=1:3 on a volume basis was used.

In addition, examples of the electrolytic solution include a known electrolyte used in a battery, such as an organic electrolytic solution obtained by dissolving at least one lithium salt selected from LiPF₆, LiBF₄, LiClO₄, LiN (C₂F₅SO₂)₂, and the like in at least one nonaqueous solvent selected from ethylene carbonate, propylene carbonate, butylene carbonate, dimethyl carbonate, ethyl methyl carbonate, diethyl carbonate, γ-butyrolactone, γ-valerolactone, methyl acetate, ethyl acetate, methyl propionate, tetrahydrofuran, 2-methyltetrahydrofuran, 1,2-dimethoxyethane, 1-ethoxy-2-methoxyethane, 3-methyltetrahydrofuran, 1,2-dioxane, 1,3-dioxane, 1,4-dioxane, 1,3-dioxolane, 2-methyl-1,3-dioxolane, 4-methyl-1,3-dioxolane, and the like, a solid electrolyte having lithium ion conductivity, a gel electrolyte, or a molten salt.

(Measurement of Discharge Capacity of Negative Electrode Using Unipolar Small Cell)

The manufactured negative electrode was processed into a size of φ6 mm. A unipolar small cell (unipolar battery) in which Li was used as a counter electrode and a separator was sandwiched by the electrodes was manufactured. Discharge capacity of the negative electrode was measured. As charge and discharge conditions, constant current charge at 0.2 CA was performed up to a lower limit voltage 5 mV, constant voltage charge was performed for 2 hours, and constant current discharge was performed at 0.2 CA up to an upper limit voltage 2.0 V. Discharge capacity obtained at this time was taken as discharge capacity of the negative electrode.

Here, 1 CA is a current value at which charge or discharge of battery capacity ends in 1 hour, and 0.2 CA is a current value at which charge or discharge of battery capacity ends in 5 hours. In a case of 0.2 CA, an influence of the thickness of the negative electrode can be ignored.

(Manufacture of Positive Electrode)

A positive electrode contained an aluminum foil as a positive electrode current collecting foil. A positive electrode mixture layer was formed on the aluminum foil. For a positive electrode active material mixture, LiNi_{1/3}Mn_{1/3}Co_{1/3}O₂ as a positive electrode active material, a conductive material of a carbon material, and a binder of polyvinylidene fluoride (hereinafter, abbreviated as PVDF) were used. The positive electrode active material mixture was manufactured so as to have a weight ratio of 90:5:5 in order, and the coating amount of the mixture was 240 g/m². When the aluminum foil was coated with the positive electrode active material mixture, the viscosity was adjusted with a dispersion solvent of N-methyl-2-pyrrolidone. After coating, the positive electrode was dried at 120° C., and then the density was adjusted by roll pressing. The positive electrode was manufactured so as to have a density of 3.0 g/cm³ in the present Examples.

(Measurement of Cycle Capacity Retention Ratio with Laminate Cell)

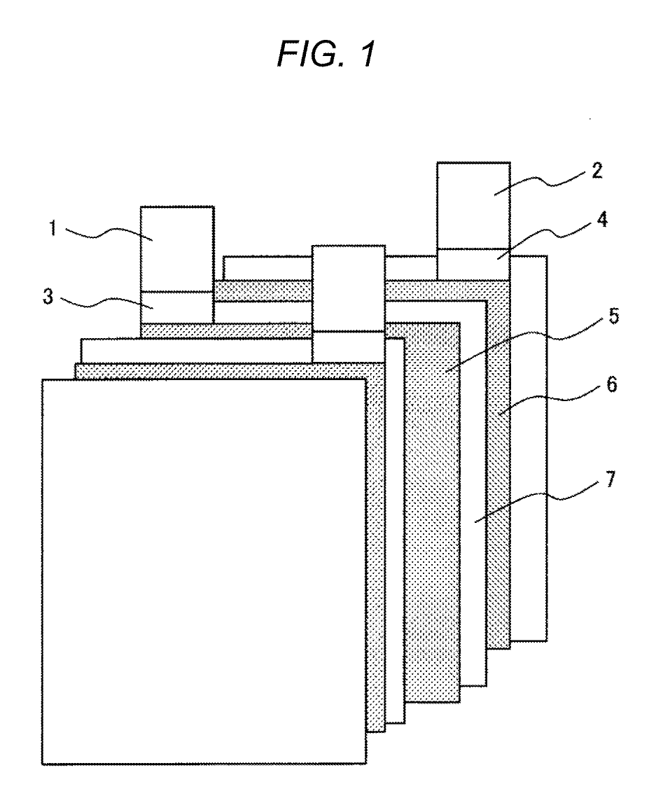

FIG. 1 illustrates an exploded view of a lamination type electrode group inside a laminate cell.

First, a lamination type electrode group inside a laminate cell was manufactured using the above positive electrode, negative electrode, separator, and electrolytic solution.

In the lamination type electrode group illustrated in FIG. 1, a plate-shaped positive electrode 5 and a strip-shaped negative electrode 6 are laminated while being sandwiched by separators 7. Note that in each of the manufactured positive electrode and negative electrode, an uncoated portion not coated with the active material mixture was formed on a part of the foil during processing. Bundled positive electrode uncoated portions 3 and bundled negative electrode uncoated portions 4 were ultrasonically welded to a positive electrode terminal 1 and a negative electrode terminal 2 for electrically connecting an inside and an outside of the battery to each other, respectively. Another welding method such as resistance welding may be used as a welding method. Incidentally, in the positive electrode terminal 1 and the negative electrode terminal 2, in order to further seal the inside and the outside of the battery, sealing portions of the terminals may be coated with a thermally welded resin, or the thermally welded resin may be attached to the sealing portions of the terminals in advance.

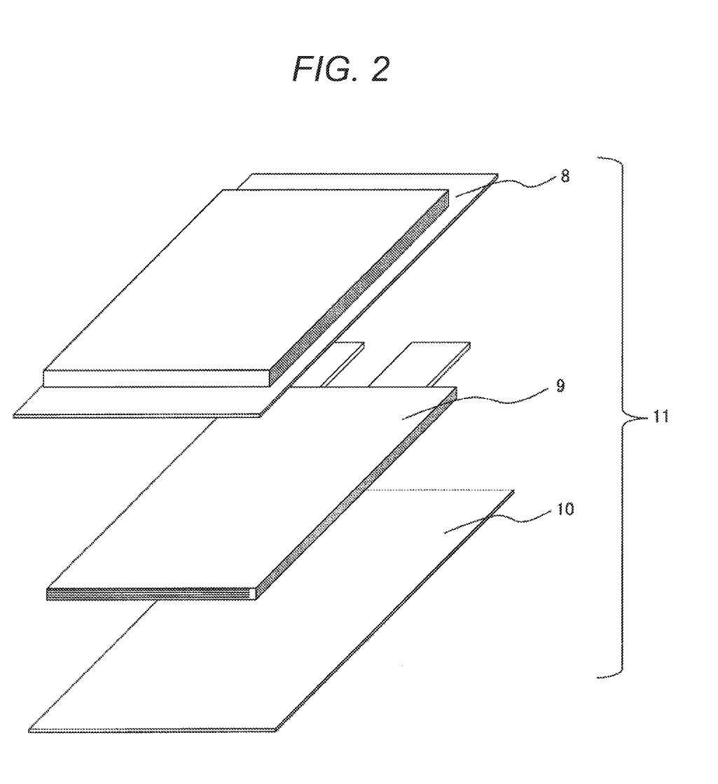

FIG. 2 illustrates an exploded perspective view of a laminate cell.

A laminate cell 11 was manufactured by causing the positive electrode terminal 1 and the negative electrode terminal 2 to penetrate an electrode group 9 while peripheries of laminate films 8 and 10 were thermally welded and sealed at 175° C. for 10 seconds to be an electrically insulated. For sealing, in order to form an injection port, first, sides other than one side were thermally welded, and an electrolytic solution was poured. Thereafter, the remaining side was thermally welded and sealed under vacuum pressurization.

Using the manufactured laminate cell, constant current charge at a voltage of 4.2 V and a current of 0.5 CA was performed, followed by constant voltage charge for 2 hours. For discharge, constant current discharge at a voltage of 1.5 V and a current of 0.5 CA was performed, and the charge and discharge were repeated 100 times. Measurement was performed by taking a ratio of the 100th discharge capacity with respect to the first discharge capacity as a capacity retention ratio of the laminate cell after 100 cycles.

(Test Result 1: Measurement Result of Discharge Capacity of Negative Electrode)

Table 3 indicates measurement results of discharge capacity of a negative electrode.

Table 3 indicates that Examples 1 to 9 and Comparative Examples 1 to 3, 5, 7, and 11 exhibited designed capacities without any particular problem, but Comparative Examples 4 to 6, 8 to 10, 12, and 13 had small capacities. In Comparative Examples 4, 6, 8, and 12, (A×B/10)>3Q is satisfied, that is, the amount of an imide group in a binder is large. Therefore, it is considered that Li is trapped by an imide group in the negative electrode binder, irreversible capacity of the negative electrode is obtained, and discharge capacity of the negative electrode is lowered. It is found that the discharge capacity is not lowered if (A×B/10)≤3Q is satisfied.

Meanwhile, Comparative Examples 9, 10, and 13 had a problem in a mixing ratio. In a case of a binder containing polyamideimide, polyimide, or polyamide, it has been found that a binding property is deteriorated, peeling occurs, and capacity is thereby lowered when the ratio of graphite with respect to the total of a Si-based active material a and a carbon-based active material b is 90 or more on a mass basis. That is, it is important that a mixing ratio of a mixed active material between a Si alloy and graphite in the present invention is 20:80 or more and 90:10 or less on a mass basis, and a mixing ratio of a mixed active material between silicon oxide and graphite is 20:80 or more and 90:10 or less on a mass basis.

TABLE 3

| | Test result 1 | |
|---|---|---|
| | Discharge capacity Q of | |
| | negative electrode | Designed capacity |
| Item | (Ah/kg) | (Ah/kg) |
| Example 1 | 800 | 800 |
| Example 2 | 800 | 800 |
| Example 3 | 800 | 800 |
| Example 4 | 800 | 800 |
| Example 5 | 850 | 850 |
| Example 6 | 550 | 550 |
| Example 7 | 1050 | 1050 |
| Example 8 | 500 | 500 |
| Example 9 | 900 | 900 |
| Comparative Example 1 | 800 | 800 |
| Comparative Example 2 | 800 | 800 |
| Comparative Example 3 | 800 | 800 |
| Comparative Example 4 | 700 | 800 |
| Comparative Example 5 | 850 | 850 |
| Comparative Example 6 | 700 | 850 |
| Comparative Example 7 | 550 | 550 |
| Comparative Example 8 | 400 | 550 |
| Comparative Example 9 | 200 | 450 |
| Comparative Example 10 | 200 | 450 |
| Comparative Example 11 | 1050 | 1050 |
| Comparative Example 12 | 700 | 1050 |
| Comparative Example 13 | 300 | 460 |

(Test Result 2: Measurement Result of Capacity Retention Ratio of Laminate Cell after 100 Cycles)

Table 4 indicates a capacity retention ratio of a cell after 100 cycles.

Table 4 indicates that Examples 1 to 9 and Comparative Examples 4, 6, 8, and 12 exhibited relatively high capacity retention ratios, but Comparative Examples 1 to 3, 5 to 7, 9 to 11, and 13 had low capacity retention ratios. In Comparative Examples 1 to 3, 5, 7, and 11, (A×B/10)<Q is satisfied, and therefore toughness (A×B) is low. Therefore, it is considered that cycle characteristics are poor. Meanwhile, Comparative Examples 9, 10, and 13 had a problem in a mixing ratio similarly to discharge capacity of a negative electrode. In a case of a binder containing polyamideimide, polyimide, or polyamide, when a ratio of graphite with respect to the total of a Si-based active material a and a carbon-based active material b is 90 or more on a mass basis, a binding property is deteriorated, peeling occurs, and it is considered that a capacity retention ratio is thereby lowered.

As described above, in the present invention, in a lithium ion secondary battery including a negative electrode, a positive electrode, and a separator, the negative electrode containing a silicon-containing Si-based negative electrode active material, graphite, and a negative electrode binder, discharge capacity Q (Ah/kg) of the negative electrode, and breaking strength A (MPa) and breaking elongation B (%) of the negative electrode binder alone satisfy the following relational formula (1).

3×Q≥(A×B÷10)≥Q (1)

As a result, a lithium ion secondary battery having excellent initial capacity and cycle characteristics can be provided.

TABLE 4

| | Test result 2 |
|---|---|
| | Capacity retention ratio |
| Item | after 100 cycles (%) |
| Example 1 | 70 |
| Example 2 | 80 |
| Example 3 | 80 |
| Example 4 | 80 |
| Example 5 | 80 |
| Example 6 | 80 |
| Example 7 | 60 |
| Example 8 | 80 |
| Example 9 | 70 |
| Comparative Example 1 | 40 |
| Comparative Example 2 | 30 |
| Comparative Example 3 | 30 |
| Comparative Example 4 | 80 |
| Comparative Example 5 | 40 |
| Comparative Example 6 | 80 |
| Comparative Example 7 | 40 |
| Comparative Example 8 | 80 |
| Comparative Example 9 | 40 |
| Comparative Example 10 | 30 |
| Comparative Example 11 | 10 |
| Comparative Example 12 | 60 |
| Comparative Example 13 | 30 |

### REFERENCE SIGNS LIST

1 Positive electrode terminal
2 Negative electrode terminal
3 Positive electrode uncoated portion
4 Negative electrode uncoated portion
5 Positive electrode
6 Negative electrode
7 Separator
8 Laminate film (case side)
9 Electrode group
10 Laminate film (lid side)
11 Laminate cell

1. A lithium ion secondary battery comprising: a negative electrode; a positive electrode; and a separator, wherein
the negative electrode contains a silicon-containing Si-based negative electrode active material, graphite, and a negative electrode binder, and
discharge capacity Q (Ah/kg) of the negative electrode, and breaking strength A (MPa) and breaking elongation B (%) of the negative electrode binder alone satisfy the following relational formula (1).
3×Q≥(A×B÷10)≥Q (1)

2. The lithium ion secondary battery according to claim 1, wherein the Si-based negative electrode active material is SiOₓ (provided that 0.5≤x≤1.5) or a Si alloy containing Si and one or more different kinds of metal elements selected from the group consisting of Ti, Al, Fe, Ni, and Mn.

3. The lithium ion secondary battery according to claim 1, wherein the discharge capacity Q (Ah/kg) is a value measured when constant current charge at 0.2 CA is performed up to a lower limit voltage 5 mV, constant voltage charge is performed for 2 hours, and constant current discharge is performed at 0.2 CA up to an upper limit voltage 2.0 V using a unipolar battery constituted by the negative electrode and Li.

4. The lithium ion secondary battery according to claim 1, wherein the discharge capacity Q (Ah/kg) is 550 or more and 1050 or less.

5. The lithium ion secondary battery according to claim 2, wherein the Si-based negative electrode active material is the Si alloy, and a mixing ratio between the Si alloy and the graphite constituting the negative electrode is 20:80 or more and 90:10 or less on a mass basis.

6. The lithium ion secondary battery according to claim 2, wherein the Si-based negative electrode active material is the SiOₓ (provided that 0.5≤x≤1.5), and a mixing ratio between the SiOₓ and the graphite constituting the negative electrode is 20:80 or more and 90:10 or less on a mass basis.

7. The lithium ion secondary battery according to claim 1, wherein the negative electrode binder is polyamide, polyimide, or polyamideimide.

8. The lithium ion secondary battery according to claim 1, wherein the breaking strength A (MPa) is strength obtained when the negative electrode binder is pulled at a rate of 0.2 m/min using a tensile tester and is broken, and is calculated from the following calculation formula (2).
A=(tensile load)/(cross-sectional area of negative electrode binder piece) (2)

9. The lithium ion secondary battery according to claim 1, wherein the breaking elongation B (%) is elongation obtained when the negative electrode binder is pulled at a rate of 0.2 m/min using a tensile tester and is broken, and is calculated from the following calculation formula (3).
B=100×{(length of negative electrode binder piece after pulling)−(length of negative electrode binder piece before pulling)}/(length of negative electrode binder piece before pulling) (3)
